(19) United States
(12) Patent Application Publication
(10) Pub. No.: US 2026/0072425 A1
(43) Pub. Date: Mar. 12, 2026

(54) Sign Detection System and Sign Detection Method

(71) Applicant: Hitachi Industrial Equipment Systems Co., Ltd., Chiyoda-ku, Toyota (JP)

(72) Inventors: Tohru NOJIRI, Tokyo (JP); Masahiko TAKANO, Tokyo (JP); Yuusuke NAKAGAWA, Tokyo (JP); Masayoshi OJIMA, Tokyo (JP)

(21) Appl. No.: 19/101,918

(22) PCT Filed: Aug. 24, 2023
(86) PCT No.: PCT/JP2023/030621

§ 371 Date: Feb. 7, 2025

(30) Foreign Application Priority Data
Aug. 31, 2022 (JP) 2022-138691

(51) Int. Cl. G05B 23/02; G06F 11/30

(52) U.S. Cl. CPC G05B 23/02; G06F 11/3058

(57) ABSTRACT

In order to achieve high accuracy of detecting a sign of cooling performance deterioration, a sign detection system includes: a pre-processing unit acquiring operation data of a time series about a cooling target apparatus and extracting features from the operation data, the cooling target apparatus including a temperature rise source and a cooling unit cooling the temperature rise source, and a sign detection unit diagnosing cooling performance of the cooling unit, based on an output obtained by inputting the features extracted from the operation data for diagnosis to a sign detection model, the sign detection model being constructed using training data generated based on the features extracted from the operation data for training and a label indicating a state of the cooling performance. The sign detection model is constructed using the training data generated based on the features extracted from the operation data including the operation statuses corresponding to the being operating and the being on standby. When diagnosing the cooling performance, the sign detection unit inputs the features extracted from the operation data including only the operation statuses corresponding to the being operating, to the sign detection model.

### TECHNICAL FIELD

The present invention relates to a sign detection system and a sign detection method.

### BACKGROUND ART

An oil cooling apparatus is provided in a cooling target apparatus, and it cools oil in the cooling target apparatus to be within an appropriate range if the cooling target apparatus is within a range of rated operation conditions. Therefore, the cooling target apparatus is not brought into an abnormal state. When cooling performance deterioration of the oil cooling apparatus occurs, however, the oil temperature in the cooling target apparatus increases, the cooling target apparatus is brought into an abnormal state, and safe and stable operation of the cooling target apparatus becomes difficult. In general, when the oil temperature increases, and the cooling target apparatus is brought into an abnormal state, a check mechanism for the oil cooling apparatus works, and operation of the cooling target apparatus stops.

Patent Literature 1 described below discloses a failure sign diagnosis system that is constituted of a diagnosis execution unit, an arrangement unit, a diagnosis target apparatus, a diagnosis server, and a network. In this failure sign diagnosis system, the diagnosis execution unit includes processing modules for sensor input processing, pre-processing, diagnosis processing, and post-processing, and a common interface connecting the processing modules, and the arrangement unit arranges the processing modules in the diagnosis target apparatus or the diagnosis server and executes them.

### CITATION LIST

### Patent Literature

### [Patent Literature 1]

Japanese Patent Laid-Open No. 2016-12157

### SUMMARY OF INVENTION

### Technical Problem

As factors in cooling performance deterioration of an oil cooling apparatus, clogging of an oil cooler, clogging of an oil filter, deterioration of the quality of oil, deterioration of oil piping, and the like can be mentioned. The cooling performance deterioration of the oil cooling apparatus appears as a difference between oil temperatures for the same load on the oil cooling apparatus. However, though a remarkable difference appears between the oil temperatures when the load is high, the difference between the oil temperatures does not remarkably appear when the load is low, and it is difficult to detect a sign of cooling performance deterioration.

An object of the present invention is to achieve high accuracy of detecting a sign of cooling performance deterioration.

### Solution to Problem

A sign detection system to be one aspect of the invention disclosed in the present application includes: a pre-processing unit acquiring operation data of a time series about a cooling target apparatus and extracting features from the operation data, the cooling target apparatus including a temperature rise source and a cooling unit cooling the temperature rise source with a cooling medium, and a sign detection unit diagnosing cooling performance of the cooling unit, based on an output obtained by inputting the features extracted from the operation data for diagnosis by the pre-processing unit to a sign detection model, the sign detection model being constructed using training data generated based on the features extracted from the operation data for training by the pre-processing unit and a label indicating a state of the cooling performance; the operation data includes operation statuses each of which indicates the cooling target apparatus being operating or being on standby; the sign detection model is constructed using the training data generated based on the features extracted from the operation data including the operation statuses corresponding to the being operating and the being on standby; and, when diagnosing the cooling performance, the sign detection unit inputs the features extracted from the operation data including only the operation statuses corresponding to the being operating, to the sign detection model.

### Advantageous Effects of Invention

According to representative embodiments of the present invention, it is possible to achieve high accuracy of detecting a sign of cooling performance deterioration. Problems, components, and effects other than those described above will be made clear by the description of the embodiments below.

### BRIEF DESCRIPTION OF DRAWINGS

FIG. 1 is a block diagram showing a system configuration example of a sign detection system according to a first embodiment.

FIG. 2 is a block diagram showing a detailed system configuration example 1 of the sign detection system according to the first embodiment.

FIG. 3 is a block diagram showing a detailed system configuration example 2 of the sign detection system according to the first embodiment.

FIG. 4 is a block diagram showing a configuration example of a cooling target apparatus.

FIG. 5 is a block diagram showing a hardware configuration example of a computer.

FIG. 6 is a diagram showing an example of a sensor data table according to the first embodiment.

FIG. 7A is a diagram showing an example of a method for creating training data according to the first embodiment.

FIG. 7B is a diagram showing an example of a training data table according to the first embodiment.

FIG. 8 shows a graph showing time-series data of discharge temperature and ambient temperature.

FIG. 9 is a flowchart showing a process for constructing a sign detection model according to the first embodiment.

FIG. 10 is a flowchart showing a sign detection process according to the first embodiment.

FIG. 11 is a diagram showing an example of a training data table according to a second embodiment.

FIG. 12 is a flowchart showing a process for constructing a sign detection model according to the second embodiment.

FIG. 13 is a flowchart showing a sign detection process according to the second embodiment.

FIG. 14 is a diagram for illustrating descriptive features according to a third embodiment.

FIG. 15 is a diagram showing an example of a training data table according to the third embodiment.

FIG. 16 is a flowchart showing a process for constructing a sign detection model according to the third embodiment.

FIG. 17 is a flowchart showing a sign detection process according to the third embodiment.

### DESCRIPTION OF EMBODIMENTS

### First Embodiment

### System Configuration of Sign Detection System 100 of First Embodiment

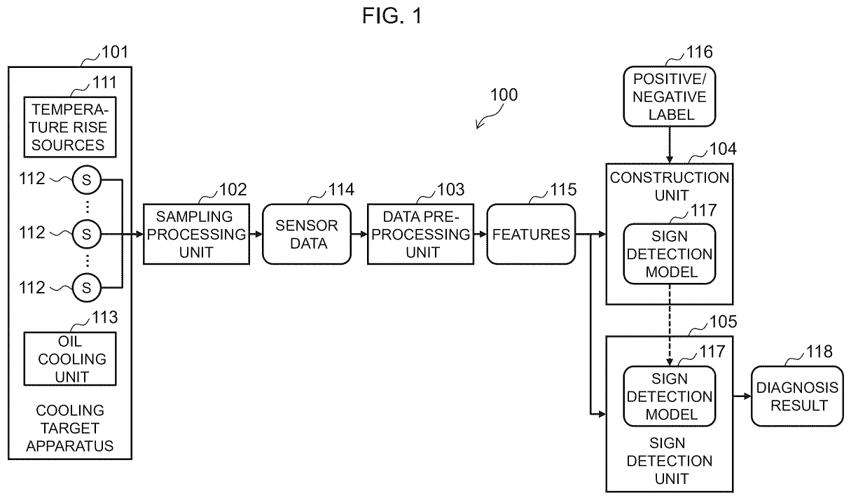

FIG. 1 is a block diagram showing a system configuration example of a sign detection system 100 according to a first embodiment. The sign detection system 100 includes a cooling target apparatus 101, a sampling processing unit 102, data pre-processing units 103, a construction unit 104, and a sign detection unit 105.

The cooling target apparatus 101 includes temperature rise sources 111, sensors 112, and an oil cooling unit 113. The temperature rise sources 111 are sources that cause temperature rise in the cooling target apparatus 101 by work on matter, such as heat generation and air compression. For example, when the cooling target apparatus 101 is an air compressor, the temperature rise sources 111 are a compression unit and a motor. The sensors 112 detect various operation conditions in the cooling target apparatus 101. The sensors 112 are, for example, a temperature sensor, an ammeter, and a pressure sensor.

The oil cooling unit 113 is a mechanism for cooling oil that circulates in the cooling target apparatus 101. Though description will be made with oil as an example of a cooling medium in the present embodiment, a cooling medium other than oil such as water or chlorofluorocarbon is also possible because which cooling medium is to be used depends on the type of the cooling target apparatus 101.

The sampling processing unit 102 converts analog data from the sensors 112 to digital and outputs it as sensor data 114.

The data pre-processing units 103 execute a pre-processing step of calculating features 115 by exclusion of outliers of the sensor data 114, interpolation of the sensor data 114, calculation of statistics of the sensor data 114 during a period going back from each of the hours by a predetermined time, and the like, and outputting the features 115.

The construction unit 104 constructs a sign detection model 117, with the features 115 and a positive/negative label 116 as training data 115D. Specifically, the construction unit 104 generates the sign detection model 117 using the training data 115D, for example, by a decision tree, a random forest, or deep learning. The positive/negative label 116 is a label indicating normality or abnormality of the cooling capacity of the oil cooling unit 113, for example, with binary flag information. Alternatively, the positive/negative label 116 may be multi-valued flag information indicating, for the cooling capacity of the oil cooling unit 113, normality thereof or a corresponding abnormality factor from among a plurality of abnormality factors.

The sign detection unit 105 executes a sign detection step of, by inputting the features 115 to the sign detection model 117, outputting a diagnosis result 118 indicating a sign of cooling performance deterioration of the oil cooling unit 113.

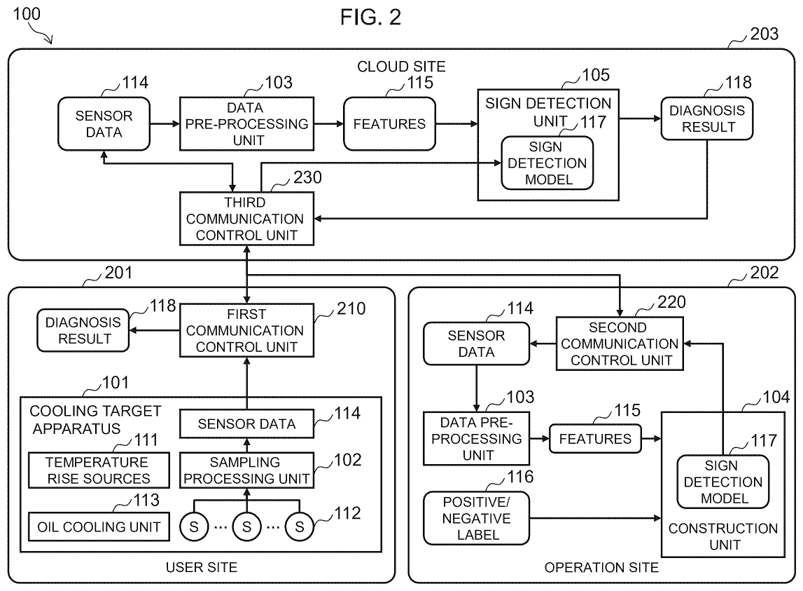

FIG. 2 is a block diagram showing a detailed system configuration example 1 of the sign detection system 100 according to the first embodiment. The sign detection system 100 includes a user site 201, an operation site 202, and a cloud site 203. The user site 201 and the cloud site 203, and the operation site 202 and the cloud site 203 are communicably connected via a network such as the internet, a local area network (LAN), or a wide area network (WAN).

The user site 201 includes the cooling target apparatus 101 and a first communication control unit 210. Though the sampling processing unit 102 is included in the cooling target apparatus 101 in FIG. 2, it may be outside the cooling target apparatus 101 as far as it is in the user site 201.

The operation site 202 includes a data pre-processing unit 103, the construction unit 104, and a second communication control unit 220.

The cloud site 203 includes a data pre-processing unit 103, the sign detection unit 105, and a third communication control unit 230.

First, a process for constructing the sign detection model 117 in the system configuration example 1 will be described. In the user site 201, the cooling target apparatus 101 outputs analog data detected by the sensors 112 to the sampling processing unit 102, and the sampling processing unit 102 outputs the sensor data 114 to the first communication control unit 210. The user site 201 transmits the sensor data 114 to the third communication control unit 230 of the cloud site 203 by the first communication control unit 210.

The cloud site 203 transfers the sensor data 114 from the user site 201, to the second communication control unit 220 of the operation site 202 by the third communication control unit 230.

In the operation site 202, the data pre-processing unit 103 acquires the sensor data 114 received by the second communication control unit 220 and outputs the features 115 to the construction unit 104. The construction unit 104 constructs the sign detection model 117 using the training data 115D (the features 115 and the positive/negative label 116) and outputs the sign detection model 117 to the second communication control unit 220. The second communication control unit 220 transmits the sign detection model 117 to the third communication control unit 230 of the cloud site 203.

In the cloud site 203, the third communication control unit 230 outputs the sign detection model 117 from the operation site 202, to the sign detection unit 105.

Next, a sign detection process by the sign detection model 117 in the system configuration example 1 will be described. In the user site 201, the cooling target apparatus 101 outputs analog data detected by the sensors 112 to the sampling processing unit 102, and the sampling processing unit 102 outputs the sensor data 114 to the first communication control unit 210. The user site 201 transmits the sensor data 114 to the third communication control unit 230 of the cloud site 203 by the first communication control unit 210.

In the cloud site 203, the third communication control unit 230 outputs the sensor data 114 from the user site 201, to the data pre-processing unit 103. The data pre-processing unit 103 outputs the features 115 to the sign detection unit 105, by excluding outliers of the sensor data 114 or by interpolating the sensor data 114 at the hour of occurrence of partial loss. The sign detection unit 105 inputs the features 115 to the sign detection model 117 and outputs the diagnosis result 118 indicating a sign of cooling performance deterioration of the oil cooling unit 113.

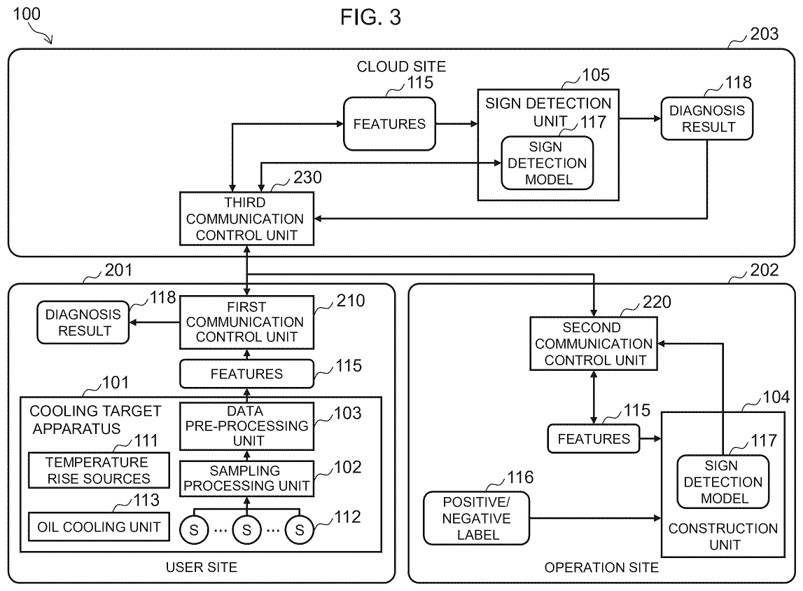

FIG. 3 is a block diagram showing a detailed system configuration example 2 of the sign detection system 100. Description will be made mainly on differences from the system configuration example 1 of FIG. 2.

The user site 201 includes the cooling target apparatus 101 and the first communication control unit 210. Though the sampling processing unit 102 and the data pre-processing unit 103 are included in the cooling target apparatus 101 in FIG. 3, they may be outside the cooling target apparatus 101 as far as they are in the user site 201.

The operation site 202 includes the construction unit 104 and the second communication control unit 220.

The cloud site 203 includes the sign detection unit 105 and the third communication control unit 230.

In the system configuration example 2, the data pre-processing unit 103 exists only in the user site 201. That is, by generating the features 115 in the user site 201, it becomes possible to construct the sign detection model 117 and detect a sign, using the sensor data 114 with a sampling period shorter than the sampling period of the sensor data 114 in the system configuration example 1.

First, a process for constructing the sign detection model 117 in the system configuration example 2 will be described. In the user site 201, the cooling target apparatus 101 outputs analog data detected by the sensors 112 to the sampling processing unit 102, and the sampling processing unit 102 outputs the sensor data 114 to the data pre-processing unit 103. The data pre-processing unit 103 outputs the features 115 to the first communication control unit 210, by excluding outliers of the sensor data 114 or by interpolating the sensor data 114 at the hour of occurrence of partial loss. The user site 201 transmits the features 115 to the third communication control unit 230 of the cloud site 203 by the first communication control unit 210.

The cloud site 203 transfers the features 115 from the user site, to the second communication control unit 220 of the operation site 202 by the third communication control unit 230.

In the operation site 202, the second communication control unit 220 outputs the features 115 from the user site 201, to the construction unit 104. The construction unit 104 constructs the sign detection model 117 using the training data 115D (the features 115 and the positive/negative label 116) and outputs the sign detection model 117 to the second communication control unit 220. The second communication control unit 220 transmits the sign detection model 117 to the third communication control unit 230 of the cloud site 203.

In the cloud site 203, the third communication control unit 230 outputs the sign detection model 117 from the operation site 202, to the sign detection unit 105.

Next, a sign detection process by the sign detection model 117 in the system configuration example 2 will be described. In the user site 201, the cooling target apparatus 101 outputs analog data detected by the sensors 112 to the sampling processing unit 102, and the sampling processing unit 102 outputs the sensor data 114 to the data pre-processing unit 103. The data pre-processing unit 103 outputs the features 115 to the first communication control unit 210, by excluding outliers of the sensor data 114 or by interpolating the sensor data 114 at the hour of occurrence of partial loss. The user site 201 transmits the features 115 to the third communication control unit 230 of the cloud site 203 by the first communication control unit 210.

In the cloud site 203, the third communication control unit 230 outputs the features 115 from the user site 201, to the sign detection unit 105. The sign detection unit 105 inputs the features 115 to the sign detection model 117 and outputs the diagnosis result 118 indicating a sign of cooling performance deterioration of the oil cooling unit 113.

### (Configuration of Cooling Target Apparatus 101)

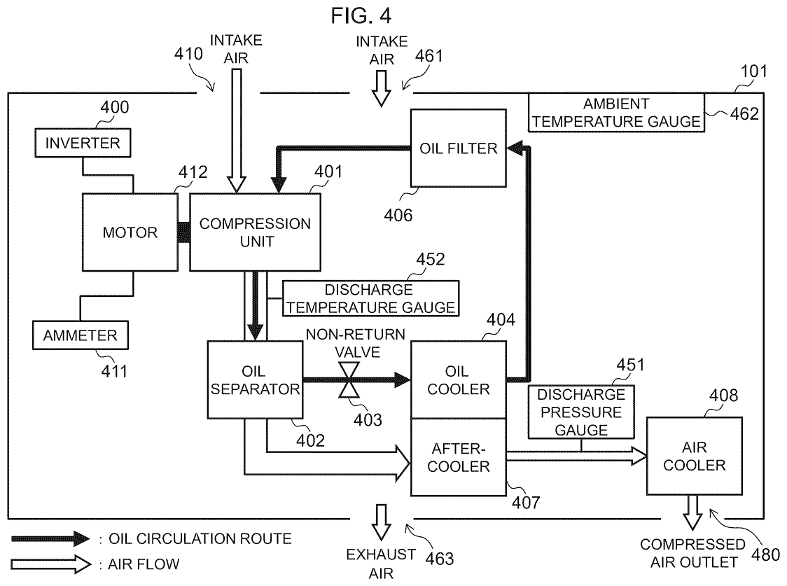

FIG. 4 is a block diagram showing a configuration example of the cooling target apparatus 101. In FIG. 4, description will be made with an air compressor as the cooling target apparatus 101. The cooling target apparatus 101 includes an inverter 400, a motor 412, a compression unit 401, an oil separator 402, a non-return valve 403, an oil cooler 404, an oil filter 406, an after-cooler 407, and an air cooler 408. The temperature rise sources 111 are, for example, the motor 412 and the compression unit 401.

The inverter 400 performs rotation control of the motor 412. When the frequency of AC voltage converted by the inverter 400 becomes higher, the load on the motor 412 increases, and the motor rotates at a high speed. Thus, a large amount of compressed air is generated by the compression unit 401. Further, the cooling target apparatus 101 includes a first air intake port 410, a second air intake port 461, an air exhaust port 463, and a compressed air outlet 480.

Further, the cooling target apparatus 101 includes an ammeter 411, a discharge pressure gauge 451, a discharge temperature gauge 452, an ambient temperature gauge 462 as the sensors 112. The ammeter 411 detects a current value of the motor 412. The discharge pressure gauge 451 detects discharge pressure of compressed air. The discharge temperature gauge 452 detects discharge temperature of compressed air mixed with oil, which is discharged from the compression unit 401. The oil separator 402 separates the compressed air mixed with the oil into the oil and the compressed air. The ambient temperature gauge 462 detects the ambient temperature of the cooling target apparatus 101, with air from the second air intake port 461. The sensor 112 also detects the voltage frequency of the inverter 400. Pieces of analog data outputted from the sensors 112 are sampled by the sampling processing unit 102 at the same timing.

The route of the compression unit 401⇒oil separator 402⇒non-return valve 403⇒oil cooler 404⇒oil filter 406⇒compression unit 401 is the route of oil circulation by the oil cooling unit 113.

Further, the route of the first air intake port 410⇒compression unit 401⇒oil separator 402⇒after-cooler 407⇒air cooler 408⇒compressed air outlet 480 is the flow of air, and compressed air generated by the compression unit 401 is discharged from the compressed air outlet 480. Further, air taken in from the second air intake port 461 cools the oil cooler 404, the after-cooler 407, the compression unit 401, and the motor 412, and is discharged from the air exhaust port 463.

### (Hardware Configuration of Computer 500)

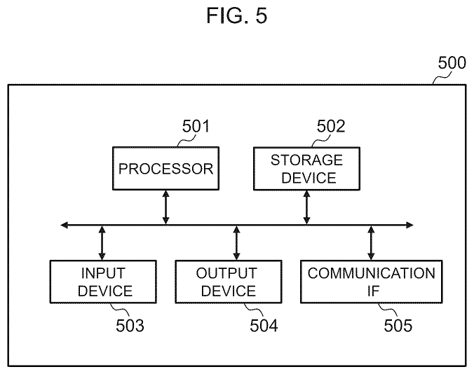

FIG. 5 is a block diagram showing a hardware configuration example of a computer 500. The computer 500 constitutes a server apparatus of each of the user site 201, the operation site 202, and the cloud site 203. The computer 500 includes a processor 501, a storage device 502, an input device 503, an output device 504, a communication interface (communication IF) 505. The processor 501, the storage device 502, the input device 503, the output device 504, and the communication IF 505 are connected via a bus 506. The processor 501 controls the computer 500.

The storage device 502 becomes a work area of the processor 501. Further, the storage device 502 is a non-transitory or transitory storage medium that stores various kinds of programs and data. As the storage device 502, there are, for example, a read-only memory (ROM), a random-access memory (RAM), a hard disk drive (HDD), and a flash memory.

The input device 503 inputs data. As the input device 503, there are, for example, a keyboard, a mouse, a touch panel, a numeric keypad, a scanner, a microphone, and a sensor. The output device 504 outputs data. As the output device 504, there are, for example, a display, a printer, and a speaker. The communication IF 505 connects to a network to transmit/receive data.

### (Data Pre-Processing)

Next, an example of data pre-processing by the data pre-processing unit 103 will be described.

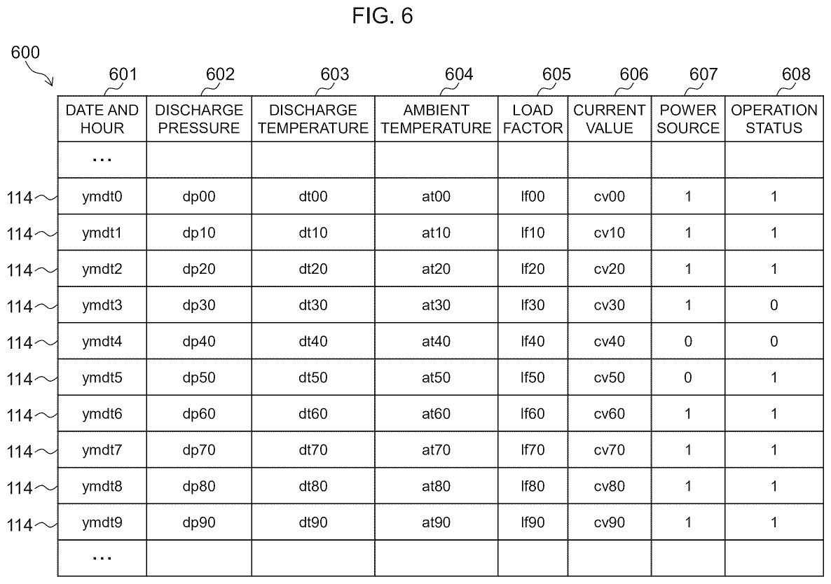

FIG. 6 is a diagram showing an example of a sensor data table. A sensor data table 600 exists in the computer 500 that holds the sensor data 114. The sensor data table 600 is a table to which the sensor data 114 is to be entered, and includes fields of date and hour 601, discharge pressure 602, discharge temperature 603, ambient temperature 604, load factor 605, current value 606, power source 607, and operation status 608.

Dates and hours 601 are dates and hours when the sampling processing unit 102 sampled analog data from the sensors 112. Discharge pressures 602 are discharge pressure values of compressed air at dates and hours when the sampling processing unit 102 sampled analog data from the discharge pressure gauge 451. Discharge temperatures 603 are discharge temperatures of compressed air mixed with oil at dates and hours when the sampling processing unit 102 sampled analog data from the discharge temperature gauge 452. Ambient temperatures 604 are ambient temperatures of the cooling target apparatus 101 at dates and hours when the sampling processing unit 102 sampled analog data from the ambient temperature gauge 462.

Load factors 605 are values indicating operation loads imposed on the motor 412 at dates and hours when the sampling processing unit 102 sampled analog data (the frequency of AC voltage) from the inverter 400. The load factor 605 increases/decreases according to the frequency of AC voltage converted by the inverter 400.

Current values 606 are values of currents applied to the motor 412 at dates and hours when the sampling processing unit 102 sampled analog data from the ammeter 411. Power sources 607 are values indicating whether the power source of the cooling target apparatus 101 at a date and hour when the sampling processing unit 102 sampled analog data from the Sensors 112 is ON or OFF.

The power source 607 takes a value of “1” when the power source is ON and takes a value of “0” when the power source is OFF. Operation statuses 608 are values indicating whether the cooling target apparatus 101 is operating or idle (on standby) at a date and hour when the sampling processing unit 102 sampled analog data from the sensors 112. The operation status 608 takes “1” while the cooling target apparatus 101 is operating and takes “0” while the cooling target apparatus 101 is idle.

### (Construction of Sign Detection Model)

Next, an example of construction of a sign detection model by the construction unit 104 will be described. The construction unit 104 executes generation of the training data 115D (the features 115 and the positive/negative label 116) and generation of the sign detection model 117 using a dataset of the training data 115D. First, generation of the training data 115D will be described.

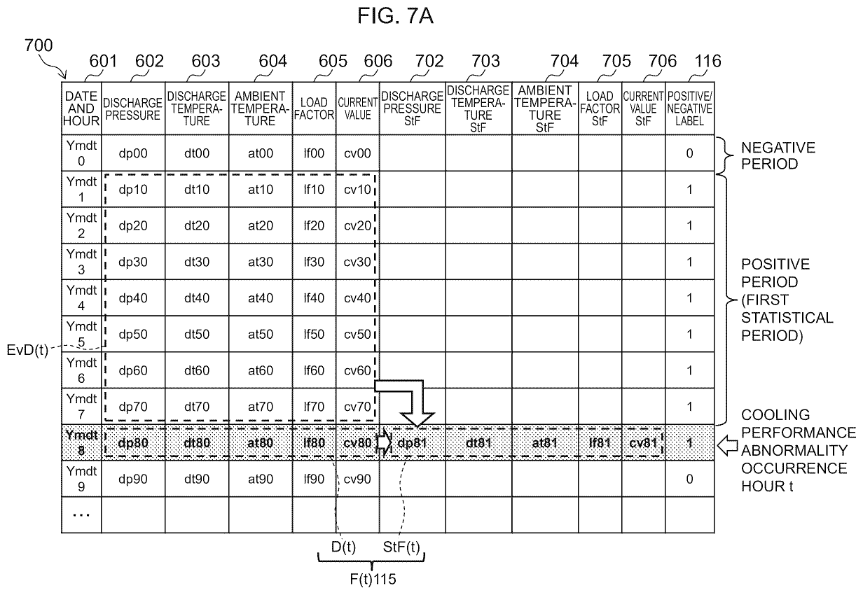

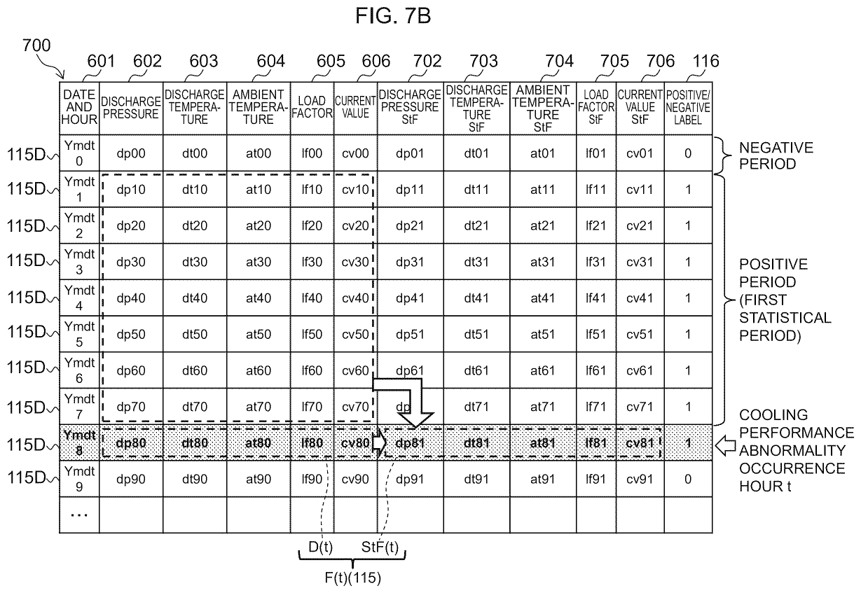

FIG. 7A is a diagram showing an example of a method for creating the training data 115D according to the first embodiment. FIG. 7B is a diagram showing an example of a training data table 700 according to the first embodiment. The training data table 700 shown in FIG. 7B exists in the computer 500 that holds the features 115.

The training data table 700 is a table to which the training data 115D (the features 115 and the positive/negative label 116) is to be entered. The training data table 700 includes fields of date and hour 601, discharge pressure 602, discharge temperature 603, ambient temperature 604, load factor 605, and current value 606. Furthermore, the training data table 700 includes fields of discharge pressure StF 702, discharge temperature StF 703, ambient temperature StF 704, load factor StF 705, current value StF 706, and positive/negative label 116. The features 115 include the discharge pressure 602, the discharge temperature 603, the ambient temperature 604, the load factor 605, the current value 606, the discharge pressure StF 702, the discharge temperature StF 703, the ambient temperature StF 704, the load factor StF 705, and the current value StF 706. Here, StF is an abbreviation of statistical feature.

The operation statuses 608 and corresponding operation status statistical features are excluded from the training data table 700. Further, the power sources 607 and corresponding power source statistical features are also excluded from the training data table 700 as items with a low degree of contribution to detection of a sign of cooling performance abnormality of the oil cooling unit 113. Items to be excluded as items with a low contribution degree are not limited to the power source 607 and the corresponding power source statistical feature StF(t) but may be decided, for example, by model evaluation of the sign detection model 117 that has been constructed.

The construction unit 104 accepts input of a date and hour of occurrence of cooling performance abnormality, by an operation input from an operator of the operation site 202. As shown in FIG. 7A, when the date and hour 601 of occurrence of the abnormality is assumed to be t1, the construction unit 104 sets a period from a date and hour going back from the abnormality occurrence date and hour t1 by a predetermine time T1 (a first statistical period) (t1-T1) to the abnormality occurrence date and hour t1 as a positive period. The construction unit 104 sets the positive/negative label 116 for the features 115 of the positive period to “1” indicating positive. Further, the construction unit 104 sets a period before the date and hour (t1-T1) to which the positive/negative label 116 is not given, as a negative period, and sets the positive/negative label 116 of the features 115 during the negative period to “0” indicating negative.

As shown in FIG. 7A, the sensor data 114 at a certain date and hour 601 (hour t) is called operation data D(t). A set of pieces of operation data D(t) included in the first statistical period relative to the hour t is called operation data EvD(t). For the operation data D(t) and EvD(t), the operation statuses 608 and items with a low degree of contribution to detection of a sign of cooling performance abnormality of the oil cooling unit 113 (in the present embodiment, the power sources 607) are excluded.

Statistics of values of the items for unions of the operation data D(t) and the operation data EvD(t) is called as statistical features StF(t) at the hour t. The statistics are maximum values, minimum values, mean values, variances, standard deviations, autocovariances, and the like. Data of a combination of the operation data D(t) and the statistical features StF(t) is the features 115 at the hour t. Data of a combination of the features 115 and the positive/negative label 116 is the training data 115D.

For example, it is assumed that the sampling period of the sampling processing unit 102 is thirty minutes. When it is assumed that the date and hour t1 is 12:30 on a certain date, and the predetermine time T1 is twelve hours, a date and hour to is 0:30 at the certain date. In this case, the data pre-processing unit 103 calculates statistics of the sensor data 114 every thirty minutes from 0:30 (the date and hour to) to 12:30 (the date and hour t1). The data pre-processing unit 103 outputs statistics of sensor data 114 at 12:30 (the date and hour t1) and sensor data 114 every thirty minutes from 0:30 (the date and hour t0) to 12:00, which is the date and hour immediately before 12:30 (the date and hour t1), as the features 115 at the date and hour t1.

By executing the above process for each date and hour 601, the training data table 700 which includes a plurality of pieces of training data 115D is generated as shown in FIG. 7B.

When the sampling period is equal to or shorter than a predetermined period, the sensor data 114 becomes huge. Especially in the case of the system configuration example 2 shown in FIG. 3, the amount of data transmitted from the first communication control unit 210 to the third communication control unit 230 increases. Therefore, when there is a limit of the amount of communication data between the user site 201 and the cloud site 203, it is not possible to transmit data from the user site 201 to the cloud site 203. In order to provide against such a case, the data pre-processing unit 103 converts the sensor data 114 to frequency components by fast Fourier transform.

For example, it is assumed that the sampling period of the sampling processing unit 102 is 10 msec. When it is assumed that the date and hour t1 is 12:30 on a certain date, and the predetermine time T1 is thirty minutes, the date and hour to is 12:00 at the certain date and hour. In this case, the data pre-processing unit 103 converts sensor data 114 every 10 msec from 12:00 (the date and hour to) to 12:30 (the date and hour t1) to frequency components by fast Fourier transform and outputs the frequency components as the features 115 at 12:30 (the date and hour t1). The features 115, which are the frequency components, may be used as they are to construct the sign detection model 117 in the operation site 202 or may be converted to time-series features 115 by performing inverse fast Fourier transform in the operation site 202.

For example, it is also possible for the data pre-processing unit 103 to output the sensor data 114 as the features 115 if the load factor 605 of the sensor data 114 is equal to or above a threshold and not output the sensor data 114 as the features 115 if the load factor 605 is below the threshold.

Further, the data pre-processing unit 103 may output sensor data 114 that is equal to or above a first threshold as first features 115 and output sensor data 114 below a second threshold lower than the first threshold as second features 115. In this case, the construction unit 104 may construct a first sign detection model 117 using the first features 115 and construct a second sign detection model 117 using the second features 115.

Further, for time-series data of the oil discharge temperature 603, in the set of pieces of time-series sensor data 114, the data pre-processing unit 103 calculates a moving average value for predetermined duration for each date and hour 601. Then, the data pre-processing unit 103 may determine pieces of sensor data 114 the moving average values of which correspond to the top po within a range between the maximum and minimum values of the moving average values calculated for the dates and hours 601, as the features 115 and output the features 115. The data pre-processing unit 103 may not output pieces of sensor data 114 the moving average values of which is below the top po as the features 115.

Further, the construction unit 104 may generate the dataset of the training data 115D for each of the features 115, by identifying a temperature rise period from a start to an end of rise of the discharge temperature 603 in the set of pieces of time-series sensor data 114.

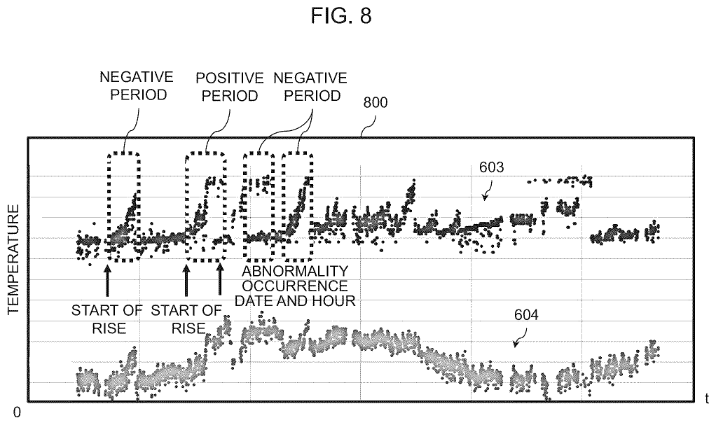

FIG. 8 shows a graph 800 showing time-series data of the discharge temperature 603 and the ambient temperature 604. On the graph 800, the construction unit 104 identifies a period with a rise trend during which the discharge temperature 603 continuously rises with a gradient equal to or steeper than a predetermined gradient. The date and hour of the start of the period is the date and hour when the discharge temperature 603 becomes the minimum value, which is the date and hour of the start of rise. Further, when the discharge temperature 603 at a certain date and hour falls to a predetermined temperature or lower (for example, the discharge temperature 603 at the date and hour of start of the rise or lower) at the next date and hour, the certain date and hour becomes the date and hour of the end of the rise. The construction unit 104 identifies the period from the date and hour of the start of the rise to the date and hour of the end of the rise, as the temperature rise period.

Then, the construction unit 104 sets the temperature rise period as a positive period if a date and hour of occurrence of cooling function abnormality is included in the temperature rise period, and sets the positive/negative label 116 for the features 115 of the positive period to “1” indicating positive. On the other hand, if the date and hour of occurrence of cooling function abnormality is not included in the temperature rise period, the construction unit 104 sets the temperature rise period as a negative period, and sets the positive/negative label 116 for the features 115 of the negative period to “0” indicating negative. Further, for periods other than the temperature rise period, the construction unit 104 may also set the periods as negative periods and set the positive/negative label 116 for the features 115 of the negative periods to “0” indicating negative.

### Process for Constructing Sign Detection Model 117 According to First Embodiment

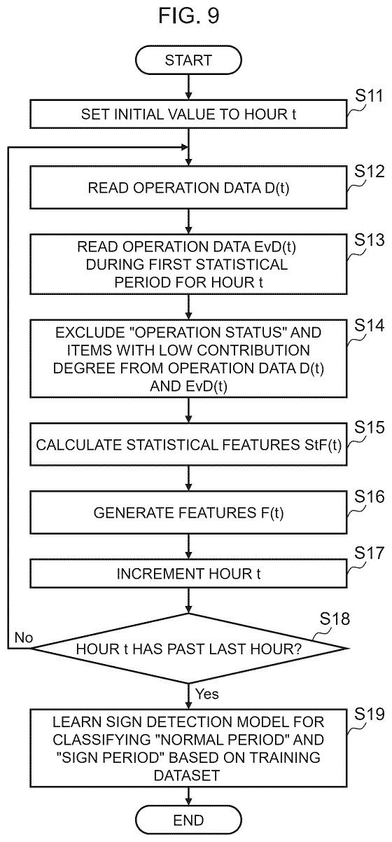

FIG. 9 is a flowchart showing a process for constructing the sign detection model 117 according to the first embodiment. The process for constructing the sign detection model 117 is executed by the construction unit 104, being triggered by input of a sensor data table 600 (FIG. 6) by a user instruction.

First, at step S11, the construction unit 104 sets an initial value corresponding to a first record of a processing target of the sensor data table 600 to t which is an hour index.

Next, at step S12, the construction unit 104 reads an entry at the hour t set at step S11 (operation data D(t) for training) from the sensor data table 600. Next, at step S13, the construction unit 104 reads an entry for a first statistical period relative to the hour t (operation data EvD(t) for training) from the sensor data table 600.

Next, at step S14, the construction unit 104 excludes the operation statuses 608 and items with a low degree of contribution to detection of a sign of cooling performance abnormality of the oil cooling unit 113 (in the present embodiment, the power sources 607) from the operation data D(t) and EvD(t).

Next, at step S15, the construction unit 104 calculates statistical features StF(t) at the hour t from a dataset of a union of the operation data D(t) and the operation data EvD(t). Specifically, for each data item of the dataset of the union of the operation data D(t) and the operation data EvD(t), a statistic is calculated as described above. Next, at step S16, the construction unit 104 combines the operation data D(t) and the statistical features StF(t) at the hour t to set the combination as features F(t) at the hour t (the features 115).

Next, at step S17, the construction unit 104 increments the hour t. Next, at step S18, the construction unit 104 determines whether the hour t has been past the hour corresponding to the last entry of the sensor data 114 or not. The construction unit 104 causes the process to proceed to step S19 if the hour t has been past the hour corresponding to the last entry of the sensor data 114 (step S18: Yes) and returns the process to step S12 if the hour t has not been past the hour.

At step S19, the construction unit 104 learns a sign detection model for classifying a “normal period” and a “sign period” based on the training data table 700 created at steps S11 to S18.

### Sign Detection Process According to First Embodiment

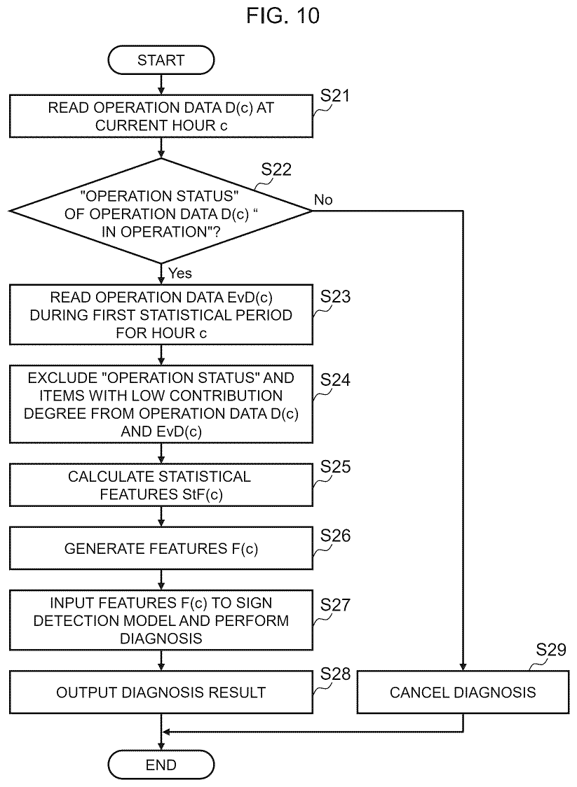

FIG. 10 is a flowchart showing a sign detection process according to the first embodiment. The sign detection process is executed by the sign detection unit 105, being triggered by input of operation data for diagnosis (the sensor data table 600 (FIG. 6) ) by a user instruction.

First, at step S21, the sign detection unit 105 reads operation data D(c) at current hour c (operation data for diagnosis). Next, at step S22, the sign detection unit 105 determines whether the value of the “operation status” of the operation data D(c) is “1” (being operating) or not. The sign detection unit 105 causes the process to proceed to step S23 if the value of the “operation status” of the operation data D(c) is “1” (being operating) (step S22: Yes), and causes the process to proceed to step S29 if the value is “0” (being idle).

At step S23, from the operation data for diagnosis, the sign detection unit 105 reads operation data EvD(c) (operation data for diagnosis) during a first statistical period relative to the current hour c. Next, at step S24, the sign detection unit 105 excludes the “operation status” and items with a low contribution degree from the operation data D(c) and EvD (c).

Next, at step S25, the sign detection unit 105 calculates statistical features StF(c) at the current hour c from the operation data D(t) and EvD (C) similarly to step S15 (FIG. 9). Next, at step S26, the sign detection unit 105 combines the operation data D(c) and the statistical features StF(c) to generate features F(c) at the current hour c.

Next, at step S27, the sign detection unit 105 inputs the features F(c) to the sign detection model 117 and performs diagnosis of the cooling capacity of the oil cooling unit 113 (calculation of the “sign period” and the “normal period) based on a positive or negative label outputted by the sign detection model 117. Next, at step S28, the sign detection unit 105 outputs a result of the diagnosis of step S26.

On the other hand, at step S29, the sign detection unit 105 cancels the diagnosis.

### Advantageous Effects of First Embodiment

In the present embodiment, the sign detection model 117 is constructed using training data 115D generated based on the features 115, which have been extracted after excluding, from the operation data D(t) that includes operation statuses 608 corresponding to being operating and being idle, the operation statuses 608. Meanwhile, at the time of diagnosing the cooling performance of the oil cooling unit 113, the sign detection unit 105 inputs to the sign detection model 117 the features 115 extracted after excluding, from the operation data D(t) that includes operation statuses 608 corresponding only to being operating, the operation statuses 608. Therefore, by excluding operation data D(t) the operation status 608 of which indicates being on standby, from diagnosis targets at the time of performing diagnosis, occurrence of false positive is avoided, the false positive being diagnosed as abnormality (positive) in the case of being normal (negative) when the status of being on standby has continued most recently, and the accuracy of sign diagnosis is improved. That is, it is possible to appropriately predict and prevent performance deterioration due to occurrence of abnormality in the cooling target apparatus 101, a stop of the cooling target apparatus 101, and failure of the cooling target apparatus 101.

Further, in the present embodiment, the features 115 includes the statistical features StF(t), which are statistics of the operation data EvD(t) at each hour t included in the first statistical period before each of time-series hours. Therefore, it is possible to appropriately predict a fault according to features of the internal conditions of the cooling target apparatus 101 related to the discharge pressure, the discharge temperature, the ambient temperature, the load factor, and the like during the most recent predetermined period.

Further, in the present embodiment, the sign detection model 117 is constructed using the training data 115D generated based on the features 115, which have been extracted after excluding, from the operation data D(t) and EvD(t) that includes the operation statuses 608 corresponding to being operating and being on standby, the operation statuses 608. At the time of diagnosing the cooling performance, the sign detection unit 105 inputs to the sign detection model 117 the features 115 extracted after excluding, from the operation data D(t) and EvD(t) that includes the operation statuses 608 corresponding only to being operating, the operation statuses 608. Therefore, by excluding the operation statuses 608 from targets at the time of constructing a model and performing diagnosis, it is possible to avoid occurrence of the false positive described above.

### Modification of First Embodiment

Though the statistical features StF(t) are included in the features 115 at the time of constructing a model and performing diagnosis in the first embodiment (FIG. 7B), the statistical features StF(t) may be excluded from the features 115.

### Second Embodiment

In the first embodiment, at the time of performing the process for constructing the sign detection model 117, the sign detection system 100 uses operation data (sensor data 114) as training data no matter whether the operation status 608 thereof indicates that the cooling target apparatus 101 is operating or idle. On the other hand, at the time of performing the sign detection process, the sign detection system 100 excludes operation data the operation status 608 of which indicates that the cooling target apparatus 101 is idle, from diagnosis targets. That is, in the first embodiment, it is not possible to perform sign detection in the case of operation data the operation status 608 of which indicates that the cooling target apparatus 101 is idle.

Therefore, in a second embodiment, the operation data the operation status 608 of which indicates that the cooling target apparatus 101 is idle, which is excluded at the time of performing the sign detection process in the first embodiment, are also targeted by diagnosis to make it possible to perform sign detection for operation data no matter whether the operation status 608 thereof indicates being operating or being idle.

That is, in the second embodiment, at the time of performing the process for constructing the sign detection model 117 and detecting a sign, the sign detection system 100 uses operation data no matter whether the operation status 608 thereof indicates that the cooling target apparatus 101 is operating or idle. Therefore, the item of “waiting status” is included in the features F(t) and the statistical features StF(t).

Hereinafter, description of the second embodiment will be made mainly on differences from the first embodiment. The second embodiment is similar to the first embodiment except the differences from the first embodiment.

### Training Data Table 700B According to Second Embodiment

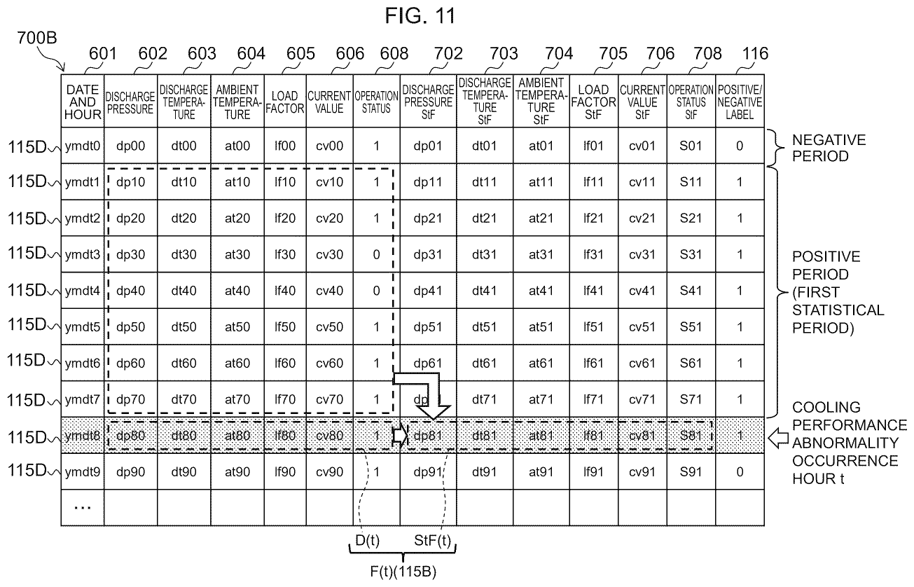

FIG. 11 is a diagram showing an example of a training data table 700B according to the second embodiment. When the training data table 700B is compared with the training data table 700 of the first embodiment, the operation statuses 608 and corresponding operation statuses StF 708 are included in the training data table 700B without being excluded therefrom. The training data table 700B is similar to the training data table 700 in other points. In the second embodiment, features 115B of the training data table 700B are used as the training data 115D instead of the features 115 of the first embodiment.

When FIG. 11 is compared with FIG. 7B of the first embodiment, the operation statuses StF 708 based on the operation statuses 608 are calculated at the time of calculating the statistical features StF, and the operation statuses 608 and the operation statuses StF 708 are included in the features 115B in the second embodiment. That is, in the second embodiment, the features 115B of the training data 115D include the operation statuses 608 and the operation statuses StF 708, which are statistical features StF of the operation statuses 608.

### Process for Constructing Sign Detection Model 117 According to Second Embodiment

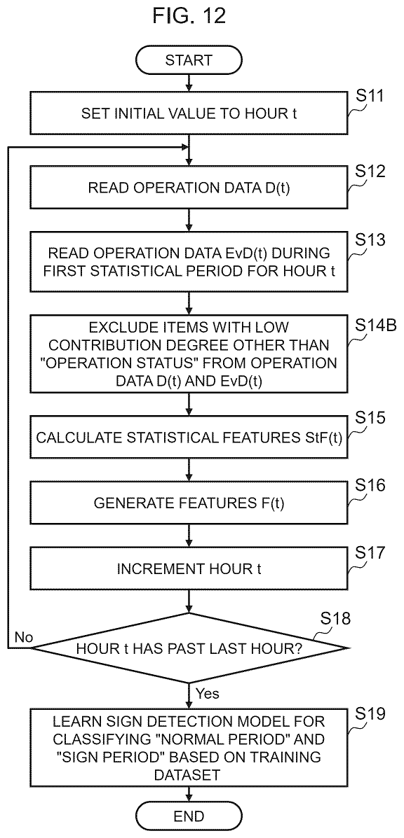

FIG. 12 is a flowchart showing a process for constructing the sign detection model 117 according to the second embodiment. In comparison with the first embodiment, the process for constructing the sign detection model 117 according to the second embodiment is different in that step S14B is executed instead of step S14, but is similar in other points.

At step S14B, the construction unit 104 excludes items with a low degree of contribution to detection of a sign of cooling performance abnormality of the oil cooling unit 113 other than the operation statuses 608, from the operation data D(t) and EvD(t). That is, the operation statuses 608 are not excluded at step S14B.

### Sign Detection Process According to Second Embodiment

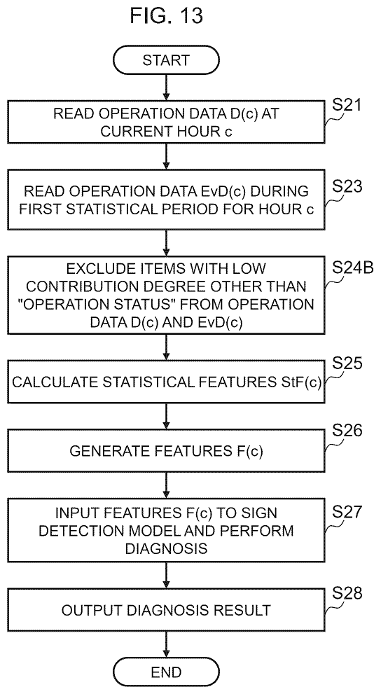

FIG. 13 is a flowchart showing a sign detection process according to the second embodiment. In comparison with the first embodiment, the sign detection process according to the second embodiment is different in that steps S22 and S29 are omitted, and step S24B is executed instead of step S24, but is similar in other points.

At step S24B, the sign detection unit 105 excludes items with a low degree of contribution to detection of a sign of cooling performance abnormality of the oil cooling unit 113 other than the operation statuses 608, from the operation data D(t) and EvD(t). That is, the operation statuses 608 are not excluded at step S24B.

### Advantageous Effects of Second Embodiment

In the present embodiment, at the time of diagnosing the cooling performance, the sign detection unit 105 inputs the features 115B extracted from the operation data D(t) and EvD(t) that includes the operation statuses 608 corresponding to being operating and being on standby, with the operation statuses 608 being included, to the sign detection model 117. Therefore, it is possible to avoid occurrence of false positive which is diagnosed as abnormality (positive) in the case of normal (negative) when the status of being on standby has continued most recently, and it is also possible to diagnose the cooling performance even during being on standby.

### Modification of Second Embodiment

In the second embodiment, at the time of generating the features 115B in the sign detection process (FIG. 13), both of the data the operation status 608 of which is “1” (being operating) and the data the operation status 608 of which is “0” (being idle) are included in the operation data D(c) and EvD(c). However, without being limited thereto, the data the operation status 608 of which is “0” (being idle) may be excluded from the operation data D(c) and EvD(c) similarly to the first embodiment. That is, it is also possible to, in FIG. 13, execute step S22 (FIG. 10) between steps S21 and S23, cause the process to proceed to step S23 in the case of step S22: Yes, and cancel the diagnosis (step S29) in the case of step S22: No.

Further, though the statistical features StF(t) are included in the features 115B in the second embodiment (FIG. 11), the statistical features StF(t) may be excluded from the features 115B.

### Third Embodiment

Since the cooling target apparatus 101 has internal conditions, there may be a case where features of appearance of a fault sign change according to a pattern of time-series changes in increase/decrease of each of discharge pressure, discharge temperature, ambient temperature, load factor, and the like during the most recent predetermined period. For example, when there is a trend of increase in the discharge temperature even though the discharge pressure, the ambient temperature, and the load factor are constant during the most recent predetermined period, it may actually lead to a fault even if a sign of the fault does not appear in the first or second embodiment.

Therefore, in a third embodiment, a pattern of time-series changes in a statistic calculated for each operation data item for each of sections obtained by separating the most recent predetermined period at equal intervals is included in features to be used for the sign detection model generation and sign detection processes. The “pattern of time-series changes in a statistic calculated for each operation data item for each of sections obtained by separating the most recent predetermined period at equal intervals” is referred to as descriptive features (PAA: Piecewise Aggregate Approximation).

### (Descriptive Features)

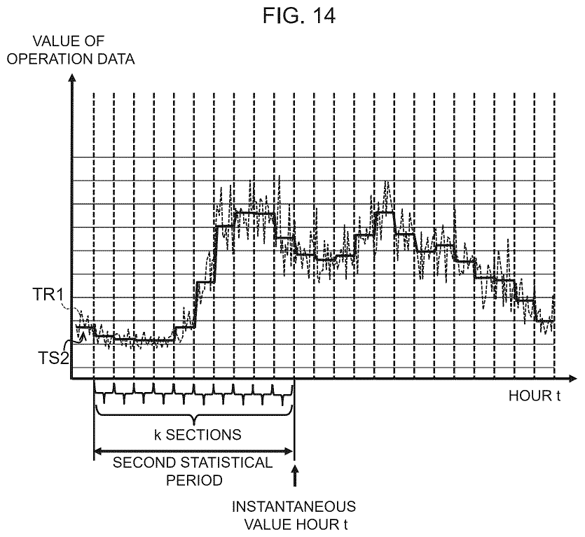

FIG. 14 is a diagram for illustrating descriptive features according to the third embodiment. The descriptive features will be described with reference to FIG. 14. A predetermined period T2 (a second statistical period) going back from certain hour t at which operation data values, which are values of items of the sensor data 114, take instantaneous values by some time, are separated into k sections at equal intervals, and a statistic of values of operation data of each section is calculated as a representative value of the section. The representative values of the k sections set as k features at the hour t are the descriptive features at the hour t.

The “k” is determined according to the second statistical period and the section length of each of the sections obtained by separating the second statistical period. The statistic of the transitive value of operation data of each section is an average value, maximum value, minimum value, median, standard deviation, skewness, kurtosis, and the like. Further, the length of each of the k sections at the equal intervals is thirty minutes, one hour, one day, one week, one month, or the like. By performing this process for each hour, instantaneous value transition TR1 becomes a time series TS2 of the representative value of each section.

In the present embodiment, description will be made on the assumption that the second statistical period has the same length as the first statistical period of the first embodiment. The second statistical period, however, is not limited to having the same length as the first statistical period. For example, the second statistical period may be longer than the section length of the first statistical section.

### Training Data Table 700C According to Third Embodiment

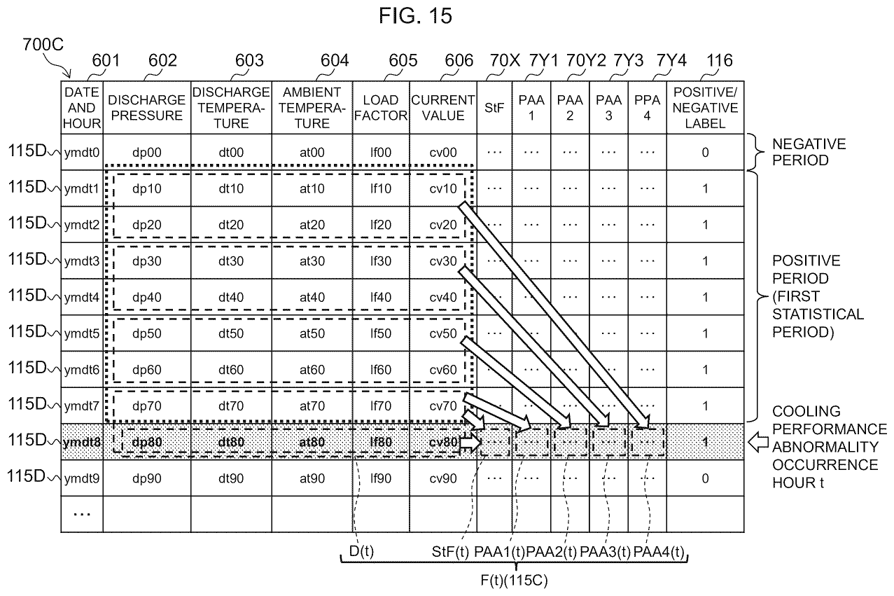

FIG. 15 is a diagram showing an example of a training data table 700C according to the third embodiment. In the training data table 700C, the operation statuses 608 and the corresponding operation statuses StF 708 are excluded from the training data table 700C similarly to the training data table 700 of the first embodiment. Further, in the training data table 700C, items with a low degree of contribution to detection of a sign of cooling performance abnormality of the oil cooling unit 113 (in the present embodiment, the power sources 607) are excluded similarly to the training data table 700 of the first embodiment.

In the training data table 700C, discharge pressures 602, discharge temperatures 603, ambient temperatures 604, load factors 605, and current values 606 are stored. Further, in the training data table 700C, statistical features StF(t) of the discharge pressures 602, the discharge temperatures 603, the ambient temperatures 604, the load factors 605, and the current values 606 are stored in the fields of StF_70X. Each of values of items of StF_70X are not shown in FIG. 15.

Furthermore, in the training data table 700C, there are fields for storing time-series descriptive features PAA(t), which are statistics of the items calculated for sections of dates and hours 601, the sections being obtained by separating the second statistical period corresponding to dates and hours “ymdt1” to “ymdt8” at which the statistical features StF(t) were calculated, into quarters. The four sections of dates and hours 601 obtained by separating the second statistical period into quarters are “ymdt1” and “ymdt2”, “ymdt3” and “ymdt4”, “ymdt5” and “ymdt6”, and “ymdt7” and “ymdt8”. Further, PAA(t)={PAA1 (t), PAA2 (t), PAA3 (t), PAA4 (t)} holds. The fields for storing the descriptive features PAA(t) in the training data table 700C are PAA1_7Y1, PAA2_7Y2, PAA3_7Y3, and PAA4_7Y4.

In FIG. 15, the items of the descriptive features PAA1 (t), PAA2 (t), PAA3 (t), and PAA4 (t) are not shown. The method for separating the period during which the statistical features StF(t) were calculated is not limited to the division into quarters.

That is, in the third embodiment, the training data 115D and diagnosis data features 115C include the statistical features StF(t) and the descriptive features PAA(t). The training data table 700C is similar to the training data table 700 in other points.

### Process for Constructing Sign Detection Model 117 According to Third Embodiment

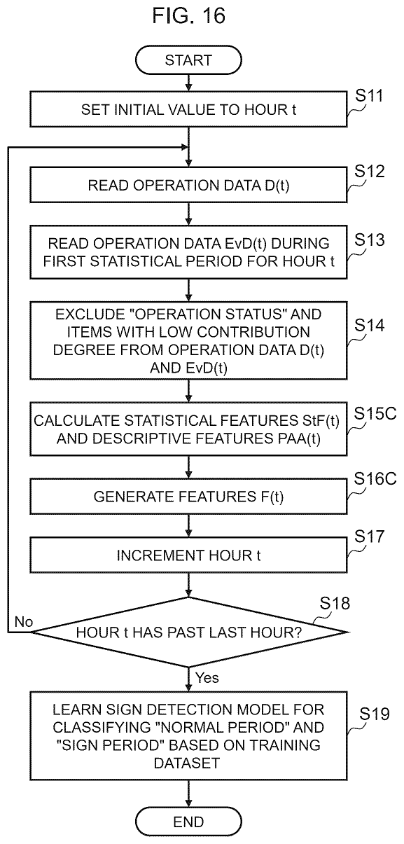

FIG. 16 is a flowchart showing a process for constructing the sign detection model 117 according to the third embodiment. In comparison with the first embodiment, the process for constructing the sign detection model 117 according to the third embodiment is different in that step S15C is executed instead of step S15, and step S16C is executed instead of step S16, but is similar in other points.

At step S15C, the construction unit 104 calculates the statistical features StF(t) and the descriptive features PAA (t) from the operation data D(t) and EvD(t). At step S16C, the construction unit 104 combines the operation data D(t), the statistical features StF(t), and the descriptive features PAA(t) to generate the features F(t).

### Sign Detection Process According to Third Embodiment

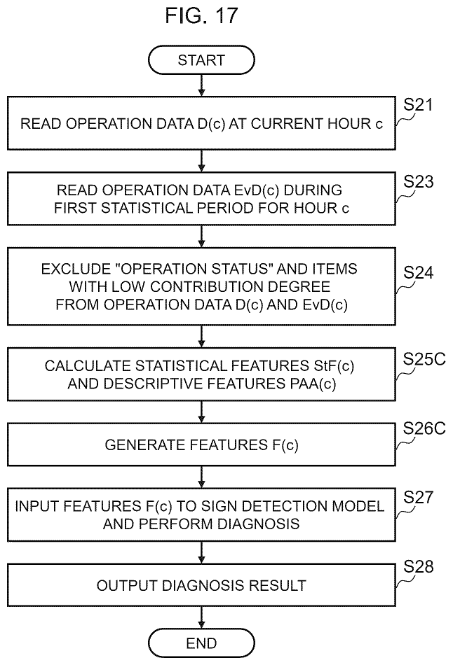

FIG. 17 is a flowchart showing a sign detection process according to the third embodiment. In comparison with the first embodiment, the sign detection process according to the third embodiment is different in that steps S22 and S29 are omitted, and steps S25C and S26C are executed instead of steps S25 and S26, respectively, but is similar in other points.

At step S25C, the sign detection unit 105 calculates the descriptive features PAA(c) together with the statistical features StF(c) at the current hour c, from the operation data EvD(c) as described before. Next, at step S26, the sign detection unit 105 combines the operation data D(c), the statistical features StF(c), and the descriptive features PAA(t) to generate the features F(c) at the current hour c.

A functional unit to calculate the descriptive features PAA(t) may be provided either in the server of the cloud site 203 or in an edge of the user site 201. If calculation of the descriptive features PAA(t) is performed in the server of the cloud site 203, a calculation load is not imposed on the edge of the user site 201, and, therefore, it is possible to avoid the limited resources of the edge from being consumed for calculation of the descriptive features PAA(t). On the other hand, if calculation of the descriptive features PAA(t) is performed in the edge of the user site 201, it is possible to avoid concentration of loads on the cloud site 203 and distribute the loads.

### Advantageous Effects of Third Embodiment

In the present embodiment, the features 115C used at the time of constructing a model and performing diagnosis include descriptive features, which are statistics of the operation data D(t) and EvD(t) at hours t included in each of a plurality of sections obtained by separating the second statistical period before each of time-series hours, and calculated for each of the plurality of sections. Therefore, it is possible to appropriately predict a fault according to features of a pattern of changes in the internal conditions of the cooling target apparatus 101 related to the discharge pressure, the discharge temperature, the ambient temperature, the load factor, and the like during the most recent predetermined period.

Further, by optimizing the length of the second statistical period and items of the operation data D(t) and EvD(t) (items of the sensor data 114) to be included in the features 115C, it is possible to introduce on-site know-how for causing the cooling target apparatus 101 to operate, which is related to fluctuations of the sensor data 114, into diagnosis. That is, it is possible to mechanically incorporate the on-site know-how into the sign detection model 117, and the necessity of determination by on-site technical experts is eliminated. Therefore, it is possible to reduce work hours of the on-site technical experts.

Further, since the second statistical period can be longer than the first statistical period, it is possible to extend a sign period during which abnormality (positive) is diagnosed, and it becomes possible to respond to prolonged lead time for sign diagnosis. For example, the operation status of an industrial machine generally shows a daily fluctuation pattern. However, by causing the second statistical period for statistical features to be shorter than one day and the first statistical period for descriptive features to be longer than one day, a fluctuation pattern other than the daily pattern can be found, and the accuracy of sign diagnosis may increase. Further, with the lead time of sign diagnosis being extended, it is possible to prepare for response to a fault with sufficient time, and therefore, it is possible to make it easy to plan implementation of response to a fault.

### Modification of Third Embodiment

In the third embodiment, at the time of generating the features 115C in the sign detection process (FIG. 17), both of the data the operation status 608 of which is “1” (being operating) and the data the operation status 608 of which is “0” (being idle) are included in the operation data D(c) and EvD(c). However, without being limited thereto, the data the operation status 608 of which is “0” (being idle) may be excluded from the operation data D(c) and EvD(c) similarly to the first embodiment. That is, it is also possible to, in FIG. 17, execute step S22 (FIG. 10) between steps S21 and S23, cause the process to proceed to step S23 in the case of step S22: Yes, and cancel the diagnosis (step S29) in the case of step S22: No.

Further, in the third embodiment, the second statistical period may be separated into smaller sections in a period during which the cooling target apparatus 101 is being busy (for example, during the day) and separated into larger sections in an operation dull period (for example, at night). By changing the section length for separating the second statistical period according to time zones with different operation conditions of the cooling target apparatus 101, it is possible to more appropriately grasp a pattern of changes in the internal conditions in a period during which changes in the internal conditions of the sign detection system 100 easily occur.

Further, though the statistical features StF(t) are included in the features 115C in the third embodiment (FIG. 15), the statistical features StF(t) may be excluded from the features 115C.

In the first to third embodiments described above, the description has been made with an air compressor as the sign detection system 100. The cooling target apparatus 101, however, may be a rolling mill or an engine.

The present invention is not limited to the embodiments described above, and various modifications and equal configurations within a spirit of accompanying Claims are included. For example, the above embodiments are described in detail in order to explain the present invention in an easy-to-understand manner, and the present invention is not necessarily limited to such that includes all the components that have been described. Further, some components of a certain embodiment may be replaced with components of another embodiment. Further, to components of a certain embodiment, components of another embodiment may be added. Further, as for some components of each embodiment, addition of another component, deletion, or replacement may be performed.

Further, as for the components, functions, processing units, processing means, and the like described above, some or all of them may be realized with hardware by designing them with an integrated circuit, or may be realized by software causing a processor to interpret and execute a program that realize each of the functions.

Information such as programs that realize each function, tables, and files can be stored in a storage device such as a memory, a hard disk, or a solid state drive (SSD), or a computer-readable non-transitory storage medium such as an integrated circuit (IC) card, an SD card, or a digital versatile disc (DVD).

Further, as for the control lines and the information lines, only those that are thought to be necessary for description are shown, and all control lines and information lines that are required for implementation are not necessarily shown. Actually, it can be thought that almost all the components are mutually connected.

### REFERENCE SIGNS LIST

100 sign detection system
101 cooling target apparatus
102 sampling processing unit
103 data pre-processing unit
104 construction unit
105 sign detection unit
111 temperature rise source
112 sensor
113 oil cooling unit
114 sensor data
115, 115B, 115C feature
117 sign detection model

1. A sign detection system comprising:
a pre-processing unit acquiring operation data of a time series about a cooling target apparatus and extracting features from the operation data, the cooling target apparatus comprising a temperature rise source and a cooling unit cooling the temperature rise source with a cooling medium; and
a sign detection unit diagnosing cooling performance of the cooling unit, based on an output obtained by inputting the features extracted from the operation data for diagnosis by the pre-processing unit to a sign detection model, the sign detection model being constructed using training data generated based on the features extracted from the operation data for training by the pre-processing unit and a label indicating a state of the cooling performance; wherein
the operation data includes operation statuses each of which indicates the cooling target apparatus being operating or being on standby;
the sign detection model is constructed using the training data generated based on the features extracted from the operation data including the operation statuses corresponding to the being operating and the being on standby; and
when diagnosing the cooling performance, the sign detection unit inputs the features extracted from the operation data including only the operation statuses corresponding to the being operating, to the sign detection model.

2. The sign detection system according to claim 1, wherein
the label indicating the state of the cooling performance of the cooling unit is a label indicating normality or abnormality.

3. The sign detection system according to claim 1, wherein
the label indicating the state of the cooling performance of the cooling unit is a label indicating normality or a corresponding abnormality factor among a plurality of abnormality factors.

4. The sign detection system according to claim 1, wherein
the features include statistical features that are statistics of the operation data at each hour included in a first statistical period before each hour of the time series.

5. The sign detection system according to claim 1, wherein
the sign detection model is constructed using the training data generated based on the features extracted from the operation data including the operation statuses corresponding to the being operating and the being on standby, after the operation statuses being excluded from the operation data; and
when diagnosing the cooling performance, the sign detection unit inputs the features extracted from the operation data including only the operation statuses corresponding to the being operating, to the sign detection model after excluding the operation statuses from the operation data.

6. The sign detection system according to claim 1, wherein
the sign detection model is constructed using the training data generated based on the features extracted from the operation data including the operation statuses corresponding to the being operating and the being on standby, with the operation statuses being included; and
when diagnosing the cooling performance, the sign detection unit inputs the features extracted from, instead of the operation data including only the operation statuses corresponding to the being operating, the operation data including the operation statuses corresponding to the being operating and the being on standby, to the sign detection model, with the operation statuses being included.

7. The sign detection system according to claim 4, wherein
the features include descriptive features that are statistics of the operation data at each hour included in each of a plurality of sections obtained by dividing a second statistical period before each hour of the time series, the statistics being calculated for each of the sections.

8. The sign detection system according to claim 7, wherein
the sign detection model is constructed using the training data generated based on the features extracted from the operation data including the operation statuses corresponding to the being operating and the being on standby, after the operation statuses being excluded from the operation data; and
when diagnosing the cooling performance, the sign detection unit inputs the features extracted from, instead of the operation data including only the operation statuses corresponding to the being operating, the operation data including the operation statuses corresponding to the being operating and the being on standby, to the sign detection model after excluding the operation statuses from the operation data.

9. The sign detection system according to claim 7, wherein
the second statistical period is longer than the first statistical period.

10. The sign detection system according to claim 7, wherein
the plurality of sections are sections obtained by separating the second statistical period at equal intervals.

11. The sign detection system according to claim 7, wherein
the plurality of sections are sections obtained by separating the second statistical period such that intervals are determined according to time zones in which the cooling target apparatus is operating.

12. The sign detection system according to claim 1, comprising a construction unit, the construction unit constructing the sign detection model using the training data.

13. A sign detection method executed by a sign detection system, the sign detection method comprising:
a pre-processing step of acquiring operation data of a time series about a cooling target apparatus and extracting features from the operation data, the cooling target apparatus comprising a temperature rise source and a cooling unit cooling the temperature rise source with a cooling medium; and
a sign detection step of diagnosing cooling performance of the cooling unit, based on an output obtained by inputting the features extracted from the operation data for diagnosis by the pre-processing step to a sign detection model, the sign detection model being constructed using training data generated based on the features extracted from the operation data for training by the pre-processing step and a label indicating a state of the cooling performance; wherein
the operation data includes operation statuses each of which indicates the cooling target apparatus being operating or being on standby;
the sign detection model is constructed using the training data generated based on the features extracted from the operation data including the operation statuses corresponding to the being operating and the being on standby; and
at the sign detection step, when the cooling performance is diagnosed, the features extracted from the operation data including only the operation statuses corresponding to the being operating are inputted to the sign detection model.

14. The sign detection method according to claim 13, wherein
the features include statistical features that are statistics of the operation data at each hour included in a first statistical period before each hour of the time series.

15. The sign detection method according to claim 13, wherein
the sign detection model is constructed using the training data generated based on the features extracted from the operation data including the operation statuses corresponding to the being operating and the being on standby, after the operation statuses being excluded from the operation data; and
at the sign detection step, when the cooling performance is diagnosed, the features extracted from the operation data including only the operation status corresponding to the being operating are inputted to the sign detection model after the operation statuses being excluded from the operation data.

16. The sign detection method according to claim 13, wherein
the sign detection model is constructed using the training data generated based on the features extracted from the operation data including the operation statuses corresponding to the being operating and the being on standby, with the operation statuses being included; and
at the sign detection step, when the cooling performance is diagnosed, the features extracted from, instead of the operation data including only the operation statuses corresponding to the being operating, the operation data including the operation statuses corresponding to the being operating and the being on standby, are inputted to the sign detection model, with the operation statuses being included.

17. The sign detection method according to claim 14, wherein
the features include descriptive features that are statistics of the operation data at each hour included in each of a plurality of sections obtained by dividing a second statistical period before each hour of the time series, the statistics being calculated for each of the sections.

18. The sign detection method according to claim 17, wherein
the sign detection model is constructed using the training data generated based on the features extracted from the operation data including the operation statuses corresponding to the being operating and the being on standby, after the operation statuses being excluded from the operation data; and
at the sign detection step, when the cooling performance is diagnosed, the features extracted from, instead of the operation data including only the operation statuses corresponding to the being operating, the operation data including the operation statuses corresponding to the being operating and the being on standby, are inputted to the sign detection model after excluding the operation statuses from the operation data.
